(19) United States
(12) Patent Application Publication
(10) Pub. No.: US 2004/0243462 A1
(43) Pub. Date: Dec. 2, 2004

(54) Method for benchmarking and scoring processes and equipment related practices and procedures

(76) Inventor: Randy S. Stier, Schaumburg, IL (US)

Correspondence Address: JOHN G TOLOMEI, PATENT DEPARTMENT, UOP LLC, 25 EAST ALGONQUIN ROAD, P O BOX 5017, DES PLAINES, IL, 60017-5017, US

(21) Appl. No.: 10/447,758

(22) Filed: May 29, 2003

(51) Int. Cl. G06F 17/60

(52) U.S. Cl. 705/11

(57) ABSTRACT

A method for scoring elected practices and procedures employed in relation to equipment and processes in the chemical, petrochemical, and petroleum refining industries has been developed. The method comprises identifying the current practices associated with a process or equipment used in the chemical, petrochemical, or petroleum refining industry and comparing the current practices with a set of best practices to generate the score. The best practices may comprise those selected from the group consisting of inspection practices, maintenance practices, instrumentation practices, training practices, monitoring practices, operating practices, and combinations thereof.

### FIELD OF THE INVENTION

The field of the invention is a method for scoring elected practices and procedures employed in relation to equipment and processes in the chemical, petrochemical, and petroleum refining industries.

### BACKGROUND OF THE INVENTION

Various methods exist for optimizing the engineering of equipment and processes in the refining and chemicals industry. For example, Talayera, P. G., Hydrocarbon Processing, July 2000 p. 69-79 and Mack, N. C.; Kaley L. C. “Reliability Program for Fired Heaters” Corrosion90 Apr. 23-27, 1990 teach engineering guidelines and calculations to rate fired heaters. None of the methods, however, address assessing the judicious election of selected means used to accomplish the end, i.e., management, of the overall unit of equipment or process as opposed to the design calculations and guidelines. This invention, through examining the management practices pertaining to equipment or processes, identifies improvements which may result in more efficient operation, reduced down time, increased safety, reduced repair costs, increased throughout, and increased product yields. Weaknesses may be identified and resources directed to those improvements that result in the greatest positive impact on the equipment or process. With measured management scores, benchmarking becomes possible, trends over time may be identified, and correlation of management scores with events or performance of equipment and processes becomes possible.

The invention provides a method of generating a measurement and standard basis of comparison in the industry as to the management of equipment and processes. The ability to compare the management of a unit of equipment or process to the management of one or more additional units of equipment or process may identify improvements that have resulted in positive performance trends in comparable equipment or processes. Also, measurements may be compared over time to monitor progression toward a goal.

### SUMMARY OF THE INVENTION

One embodiment of the invention is a method for determining a management score comprising identifying the current practices associated with a process or equipment used in the chemical, petrochemical, or petroleum refining industry and comparing the current practices with a set of best practices to generate a management score. The process may be refining processes, petrochemical, and chemical processes such as alklylation, polymerization, cracking, reforming, isomerization, hydrotreating, sulfur removal processes, aromatics processes, gasification, separations, blending, and combinations thereof. The equipment may be those such as fired heaters, rotating equipment, heat exchangers, boilers, piping, vessels, instrumentation and combinations thereof. In the preferred embodiment the management score is numerical. The best practices comprise those selected from the group consisting of inspection practices, maintenance practices, instrumentation practices, training practices, monitoring practices, operating practices, and combinations thereof.

In another embodiment of the invention, the method further comprises determining a category management score by identifying the current practices associated with a category of a process or equipment used in the chemical, petrochemical, or petroleum refining industry, the category selected from the group consisting of inspection practices, maintenance practices, instrumentation practices, training practices, monitoring practices, operating practices, and combinations thereof, and comparing the current practices with a set of best practices associated with the selected category to generate a category management score. The method may be repeated the method to generate a second management score, and the management score may be compared with the second management score.

### BRIEF DESCRIPTION OF THE DRAWINGS

FIG. 1 is a chart showing the flow of the invention.

### DETAILED DESCRIPTION OF THE INVENTION

The present invention provides operating companies with a method of self-assessing their handling or management of process and equipment performance and also provides a basis of discussion of process and equipment performance management practices from individual equipment-to-equipment and site-to-site. Additionally, as a result of this invention, documentation as to practices employed will already exist before equipment fails. Lessons learned can then be communicated easily and practices changed to prevent similar failures elsewhere.

In general terms, the method of the invention identifies current practices used in the management and operation of a process or a unit of equipment. The method then compares the identified current practices to a predetermined set of best practices and notes which best practices are currently in place and which are not. Based on this information, the method assigns a management score to each process or unit of equipment reflecting how well the performance of the process or equipment is being managed. The management scores resulting from this invention can provide a basis for setting equipment management improvement goals and periodically repeating the process of this invention will demonstrate measured progress toward achieving identified goals. Multiple management scores may be complied to form a body of information. Any particular score may then be compared to a target management score, one or more in the collection of management scores or a mathematical representation of a function of the management scores. The management scores will provide a basis for benchmarking in relation to other equipment or processes or with respect to time. Also, the present method benchmarks current practices against best practices in a systematic way to highlight areas to focus resources to improve process or equipment performance. What is considered an acceptable management score will vary with the criticality of the service and the output requirement of the equipment or process. Particular attention may be paid to identifying performance management practices that have led to process or equipment failures in the past.

The method may be applied to a wide variety of processes and equipment in the chemical, petrochemical, and petroleum refining industries. Processes may include alklylation, polymerization, cracking, reforming, isomerization, hydrotreating, sulfur removal processes, aromatics processes, gasification, separations, and blending such as product blending.

The types of equipment that may benefit from the application of the present invention include equipment such as equipment having rotating parts such as pumps and condensers, heating devices such as heat exchangers, fired heaters, and boilers, cooling devices such as heat exchangers, air coolers and water towers, instrumentation such as thermocouples, pressure gauges, meters, regulators, valves, on-line analytical instrumentation, laboratory analytical instrumentation, containment devices such as piping, vessels and tanks, mixing devices such as static mixers, and mix tanks, filtering devices such as screens, pads and coalescers, catalyst handling devices such as storing loading moving and unloading equipment, and fractionation equipment such as trays, downcomers, valves, wiers, packing, and spray bars.

Historical information about the equipment of process being evaluated may be helpful to gather. The historical information for equipment or processes may comprise items such as name and location of the equipment or process, service description, year designed, expected flows through the equipment or process, expected duty, expected operating temperature, metallurgy, environment of the equipment or process, fuels used, associated equipment, failure record, and common causes for failure.

Achieving high availability and long life of equipment and of processes requires good practices such as inspection, maintenance, instrumentation, training, monitoring and operating practices. Therefore, in one embodiment of the invention, the method compares current practices to best practices in at least these six areas: inspection practices, maintenance practices, instrumentation practices, training practices, monitoring practices, and operating practices. Generally, the category of inspection practices includes those where mechanical and structural integrity is verified; maintenance practices include restoring equipment to peak operating condition; instrumentation practices include monitoring process and equipment parameters during operation; training practices include instructing personnel on theory, techniques, and practices; monitoring practices include tracking parameters over a period of time, and operating practices include the day-to-day methods of operating the equipment or process.

The best practices in each of the six categories are identified. It is preferred that the best practices be identified in a general and broad manner and not specific to individual circumstances such as geography, refiner, age of refinery operation and the like. Through identifying the best practices on a broad basis, the best practices would be applicable to a wide variety of equipment or processes regardless of where located or who operated by. This approach would allow for the management scores determined by this method to have a common basis and therefore be comparable across a large number of equipment units or processes. A common basis of comparison is especially beneficial when benchmarking a specific equipment unit or process against others in the industry, or predicting the performance of a unit or process based upon the management score and correlations established based upon the management scores. Examples of best practices in the inspection practices category are found in the specific embodiment of the invention as applied to a fired heater as described in detail below.

Having an identified set of best practices, the method requires a set of current practices to be identified. The current practices are those practices that are currently in place and being followed for the equipment or process being evaluated. The current practices are identified through inspecting the equipment or process, gathering information from individuals, documentation, records, and plant data historians associated with the equipment or process. The identified current practices are recorded.

One embodiment of the invention uses a computer to query whether best practices are in current use and with the computer recording the responses. For example, the predetermined set of best practices would be used to establish a series of questions that would be answered by an individual with access to and/or knowledge of the equipment or process under evaluation. The individual may be one who ordinarily is associated with the equipment or process being evaluated, or may be an individual who coordinates input from a variety of sources. The questions could cycle through the set of best practices with the answers indicating whether the best practice is in current use. Of course, the current practices identified may be recorded in a variety of ways including manual writings, photographs, charts, raw data, video recording, and tape recording, but a preferred mode is through the use of computer technology. This method could require a single computer, or a first computer at a location convenient for the equipment or process operator could be used to identify the current practices with the collected data being easily communicated to a second remote location for calculation of the management score. The second or remote location could also utilize a computer with the communication between the first and second computers being electronic. Similarly, the management score and details such as sub-score (discussed below) could be communicated to the first location electronically. The method of the invention is readily applicable to an internet-based mode of operation or an e-mail based mode of operation.

Once the best practices have been identified and the current practices have been identified, the current practices are compared to the best practices. Which of the best practices are found to be a current practice, and which of the best practices are not currently employed are noted. It must be emphasized that this method is fundamentally different from those methods that optimize engineering performance such as found in Talayera, P. G., Hydrocarbon Processing, July 2000 p. 69-79. In the Talayera reference, calculations of technical aspects of a fired heater are evaluated in order to rate the efficiency and reliability of a heater. Calculations of combustion reactions to determine air requirements and flue gas generation, heater efficiency to determine fuel savings, flame height to determine potential tube flame impingement, stack and heater hydraulics to determine heater limits, process side heater transfer to determine fouling, tube elastic and rupture analysis to determine tube life at a minimum thickness, and economic evaluation to optimize profitability are all used to rate a heater. Contrary to the above reference, in this invention, it is the particular practices employed that are compared to the identified best practices to determine a management score. The greater number of best practices that are employed as current practices, the greater the resulting management score. The overall management of the equipment or process is being rated, not merely the optimization of specific technical aspects such as utilities usage, throughput, yield, capacity, heat transfer, economics, and the like. The management score generated by the invention is a novel value in the chemical, petrochemical, and refining industry that provides a measure unlike any that have been traditionally employed for individual processes and equipment.

As a result of comparing the identified current practices to the best practices, a management score is determined. The score may be determined in a large number of different ways. One embodiment calls for mathematically calculating the management score. For example, the method could note each of the best practices that are in place and practiced with respect to one identified fired heater. In a simplistic model, the management score could be a percentage representing the number of the best practices that are actually performed. If one half of the best practices were performed, the management score would be e.g., 50, if three-quarters of the best practices were performed the management score would be e.g. 75 and so on.

However, a more meaningful model would be one where the best practices were weighted according to the effect that each practice had on the overall performance of the equipment or process. The greater the effect of a best practice, the more that practice would be weighted in the calculation of the management score. Therefore, in one embodiment, the identification of the best practices would include an assignment of a weighted value to each best practice. The management score could be the sum of the values assigned to those best practices that were currently practiced in an application, or the score could be expressed as a percentage of the total sum of values for all the best practices. In other embodiments, the management score could be communicated pictorially in charts, graphs, or using level codes such as color or grade levels.

In a broad sense, the management score is an overall measurable value indicating the quantity of best practices that are employed in the management of a unit of equipment or a process. Such an overall management score is particularly useful in comparing the management of a first unit of equipment or process with other units of equipment or processes. With a collection of management scores, statistical information such as industry averages may be determined, or other correlations may be determined. Therefore, a valuable embodiment of the invention is one where management scores from similar equipment or processes are maintained in a collective set. Computer-related technology such as electronic databases or spreadsheets is a means of readily storing and using the collective set of data. Through comparing a selected management score to others in the collective set of scores, the method may be useful in identifying those units or processes that would benefit from modifying or revising current practices. The method is also useful for quantifying risk, such as risk of failure, capital planning, and as investment data. Similarly, management scores of a single unit of equipment or process determined at different points in time may be collected as a set. The set could be used to demonstrate measured progression toward a goal.

In yet another embodiment of the invention, one or more category management scores may be determined in addition to the overall management score. As discussed above, current practices are identified in at least one category such as inspection practices, maintenance practices, instrumentation practices, training practices, monitoring practices, and operating practices. An independent management score calculation may be performed on one or more of the sets of data pertaining to only one selected category. For example, a management score may be determined for only inspection practices. This inspection practices management score may then be compared to other inspection practices management scores which may make up an industry average or expected value. In this way, the invention could be used to identify those categories that are within accepted ranges and those that are not. Resources could be targeted to those categories with the lowest category management score.

It is still another embodiment of the invention that the management scores or the category management scores may be correlated with difficulties the equipment or process may be experiencing. For example, a correlation may emerge that those operations with low management scores suffer a greater number of non-operational days or those with low maintenance practices management scores suffer an increased number of equipment failures. One of skill in the art would readily understand how the invention could be applied to forecast a wide variety of potential outcomes.

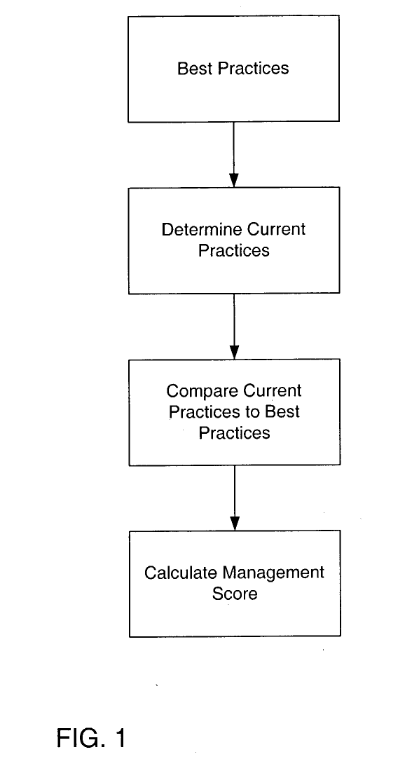

As an example of one specific embodiment of the invention, the following is a description of the method as applied to a fired heater to determine the management score of the care and operation of that fired heater. The focus of the example on this specific embodiment is not meant to limit the generally broad scope of the invention and one of ordinary skill in the art would readily understand how to apply the method of the invention to other processes and equipment. The example follows the flow shown in FIG. 1. First, the best practices are determined. Then the current practices are determined. The current practices are compared to the best practices and the management score(s) are calculated.

Best practices would be determined for each of the management areas for the fired heater of interest, inspection practices, maintenance practices, instrumentation practices, training practices, monitoring practices, and operating practices. The best practices in each management area may be sub-divided into subcategories within the management area. For example, best inspection practices for a fired heater may include the subcategories of external inspection of the fired heater, inspection of auxiliary fired heater equipment, inspection of fired heater fans and external heat recovery equipment, inspection of fired heater refractory, inspection of fired heater tubes and tube supports, reporting, record keeping and analysis. Within each subcategory of inspection practices, further specific items may be identified. The collective of the specific items, the subcategories and the management areas form the best practices of the fired heater. As illustration, a set of best inspection practices of a fired heater grouped according to the above-mentioned subcategories is provided.

The following may be part of the best practices of external inspection of a fired heater. Visually inspect the exterior of the stack and the heater setting. Look for stack leaning, hot spots, paint failures, external corrosion, corrosion perforations in the stack and casings from acidic flue gas. Visually check structural members and casing panels for heat distortion, warping and cracked welds. Measure exterior temperatures with an infrared camera. Visually inspect bolting at base flange and elevated sections of the stack for tightness, corrosion and breakage. When the heater is not running, test the stack and casing to check for acidic flue gas corrosion thinning. When necessary, expand inspection and obtain thickness measurements to determine the extent of damage. Visually inspect tube penetration seals, manifold support seals, view port doors, access doors and explosion doors. Check fit to determine if fit is satisfactory to prevent air ingress. Verify that heater panel joints are seal welded or caulked with high temperature silicone sealant. Inspect hinges of explosion doors and the door for warping. Lift doors to check its operation.

Examples of the best practices in the subcategory inspection of auxiliary-fired heater equipment include the following. During internal inspections, inspect all combustion air and flue gas dampers for oxidation and warping. Visually inspect supporting brackets, driving rods, pins and other devices for in-service deterioration. Check damper controls during the turnaround to ensure the damper can open and close properly with acceptable lag time between signal and damper movement. Hammer test and visually inspect steam smothering lines that enter the bottom of the radiant section and the convection header boxes including vertical sections up the side of the heater. Inspection is started at the steam block valve that is remote from the heater. Corrosion attack is most aggressive to the bottom of horizontal runs and at dead legs. Check to see if weep holes in bottom of the line are plugged preventing condensate from draining. Inspect sootblowers for proper operation, proper alignment, proper position and warping. Examine the sootblower, supporting hangers and brackets for soundness and excessive oxidation. Prior to the turnaround, assemble copies of the burner vendor drawings and data sheets for use during the inspection. During the turnaround, visually inspect gas and oil burners for oxidation, broken parts, fouling and plugging. Visually inspect muffler and burner blocks for breakage or deterioration. Inspect air registers for debris and dampers for freedom of operation. Check to ensure correct burner tips are being used. Check the size of the ports using drill bits. Check to ensure all burner dimensions are within the tolerances listed on the burner vendor's drawings. Check tip location against drawings to verify height in tile. Check tip orientation by temporarily placing welding rods into the tip ports. Check to ensure burner tile is concentric with proper diameter. Verify that burner tile is level, and if not level, determine if tilt is caused by a warped heater floor (or wall for wall fired burners). Inspect the fuel gas lines from the knock-out drum to the burner tips. Report the presence of any scale or deposits. Send scale and deposit samples to the laboratory for analysis. Ensure the fuel gas line insulation is in good condition and that the tracing is in good working order.

The following may be part of the best practices for the subcategory inspection of fired heater fans and external heat recovery equipment. For forced draft and induced draft fans, quarterly, measure vibration severity based on bearing housing vibration measurement as a function of operating speed. Monthly, inspect V-belt alignment and tension. Inspect fan, driver baseplate and mounting. Quarterly, measure and record bearing housing temperature. For grease lubricated method, review the grease lubrication schedule and verify that the manufacturer's intervals for grease lubrication is followed. Verify the proper grease is in use and check quantify of grease in housing. During downtime, check fan alignment, belt tension and, confirm fan and motor sheaves are aligned axially. If necessary, improve position using motor feet adjustment bolts. Remove housing inspection door, if present and inspect wheel visually for accumulation of deposits. Confirm damper position is in same physical position as it reads externally. Check that the damper assembly is properly lubricated and moves freely. Verify there is no insulation of damper boxes with damper blade shaft bearings at higher fan operating temperatures. Verify the inlet ductwork provides good flow streamline to impeller eye. Verify the ductwork is installed and supported to minimize loading on fan housing. Disconnect the inlet and outlet and measure and record offset. Look to see if the fan housing moves when the ductwork is released. Verify there is reflective tape on visible section of the shaft such that a strobe tachometer can be used during operation. For the flue gas and combustion air exchanger, when using a cast iron recuperative type unit, inspect the exchanger for deposits, perforations to the heat transfer surfaces, integrity of the gaskets, functionality of the sootblowers or water washing systems, corrosion of the casing and duct work. Perform a smoke test to verify the integrity of the heat transfer surface and gasketing. Clean and neutralize the heat transfer surfaces if the exchanger is water washed. When using glass tube units, inspect the exchanger for deposits, breakage/cracking of the heat transfer surfaces, integrity of the tubesheet seals, functionality of any sootblowers or water washing systems, corrosion of the casing and duct work. Perform a smoke test to verify the integrity of the heat transfer surface and seals. When using regenerative heat wheel type exchangers, inspect the exchanger for deposits, perforations and corrosion of the heat transfer surfaces, integrity of the seals, functionality of the sootblowers or water washing systems, corrosion of the casing and duct work. Inspect the gas seals for distortion. Inspect plate type or other types of exchangers for deposits, the integrity of the heat transfer surface, and corrosion of the exchanger and the enclosure. Smoke test the heat transfer surface for leaks. For the LP steam and combustion air exchanger, examine the steam coil for damage or fouling on the air side. Pressure leak test the exchanger to confirm its integrity. For the steam drum and blowdown drums, open and internally inspect the steam drum. Perform an inspection of internals for damage, missing nuts and bolts, leakage or bypassing. Examine the steam drum for the uniformity/consistency of the water level and any corrosion/erosion that may be occurring. Check the steam purity sample probe for damage or plugging. Examine the mesh or chevron purification equipment for damage, plugging or bypassing. Determine readability of any level gauge glasses. Check level instrumentation for calibration. Blowdown drums with internals, such as demisters, are opened and examined for damage. Erosion in the inlet line area are checked for on occasion if no internals are present.

Similarly, the following may be part of the best practices for the subcategory of inspection of fired heater refractory. Conduct a quarterly IR scan of all visible refractory surfaces during operation. Visually inspect firebrick for loose, missing, crumbling, breaks and open joints. Ensure sufficient space is left for thermal expansion of firebrick. Visually inspect and hammer test all accessible castable refractory areas. Inspect castable refractory for cracks, corrosion, erosion, fluxing, bulging and spalling. Hammer test all accessible castable areas for large air pockets or indications that the lining is laminated. Look for castable refractory cracks over 1/16″ (2 mm) wide. Recommend repairs for cracks greater than ⅛″ (3.2 mm). Recommend loose refractory be repaired. For refractory cracks, check casing in area of cracking for hot spots. If hot spots are found, recommend refractory in affected area of hot spot be replaced. Monitor any refractory repairs. Verify the casing is clean and is dry prior to making repair. Visually inspect anchors, recommend oxidized or broken anchors be replaced and additional anchors be added when needed. Visually inspect ceramic fiber blanket, ceramic fiber modules and fiberboard insulation for deterioration, shrinking, erosion, missing, peeling or torn panels. Scrape the ceramic fiber to determine the depth of damage. Check for burned off anchor tips, broken or missing washers, and studs loose enough to wiggle. When repairs are made exposing anchors, visually inspect and hammer test them to determine their condition.

The following may be part of the best practices of the subcatagory of inspection of fired heater tubes and tube supports. Visually inspect tube supports and tube sheets for cracks, oxidation or corrosion. Conduct quarterly infrared scans to determine radiant tube support temperatures and of the heater coil to detect hot spots. During operation, visually inspect heater tubes for sagging or bowing. Estimate the length and height of the sag or bow. Visually inspect tube hangers and guides for cracks, oxidation and corrosion. When inspecting hangers and guides, check the tubes for wear at points of contact. Check radiant tubes for bulging or swelling using tube gauges. Strap suspect areas to determine the exact diametrical growth. Visually inspect heater tubes for oxidation, scale, cracking, splitting, external corrosion and deposits. Determine the actual corrosion rate based upon thickness measurements. Measure the hardness of the tubes at each of the thickness measurement locations. Calculate the combined pipe stress resulting from internal pressure, tube weight, process weight, tube distortions and non-uniform temperature distribution around the tube. Set tube retirement thickness. Cut tube samples for destructive testing when a tube operates for more than a set period of time at specified temperatures based on tube metallurgy. Use Omega methods to calculate remaining tube life and recommend when tube samples should next be taken. Check for signs of carburization throughout the depth of the tube wall thickness. Measure the tensile stress, yield stress, percent reduction of area and ductility. Replace tubes that fall below the minimum standards for these values as listed in the corresponding ASTM specification defining the tube metallurgy. Measure the LOI and metals content of internal scale deposits. During the turnaround, determine the type and thickness of fouling on the outside of the tubes in both the convection and radiant sections. Hammer test carbon steel tubes and low alloy tubes for signs of thinning or coke buildup inside a tube. Use X-ray techniques to detect and measure the thickness of coke deposits inside austenitic stainless steel or cast tubes.

The following may be part of the best practices for reporting, record keeping and analysis. Each inspection is documented on an approved inspection form. The following information is reported as applicable: Components inspected. Results of measurements taken. Passed and failed inspections. Report all deficiencies and reasons why an item failed inspection. Type and location of deficiencies found. Inspection recommendations and subsequent action taken. Maintenance repairs and replacements. Detail materials used for repairs. Inspection reports and information are maintained electronically in a data management system. Inspection reports are used during the decision making process on fired heater integrity and performance.

The best practices of the remaining management areas, maintenance practices, instrumentation practices, training practices, monitoring practices, and operating practices, and their corresponding subcategories are determined and listed in a similar fashion to that of the inspection practices shown in detail above.

As shown in FIG. 1, once the collective of best practices have been identified, the current practices and procedures regarding the care and operation of the fired heater of interest that are in place at the time the invention is being applied are investigated. Different ways to determine the current practices are discussed above. One embodiment involves talking with individuals accountable for the operation and maintenance of the fired heater. The method flow chart of FIG. 1 next indicates that the current practices are compared to the best practices. Table 1 shows the comparison of the current practices to the best practices for the sub-category of the external inspection of a fired heater (best practices described in paragraph [0024] above). The left column shows the best practices and the right column indicates whether a selected best practice is currently performed with respect to the fired heater.

TABLE 1

| | CURRENT |
|---|---|
| BEST PRACTICES | PRACTICE |
| Visually inspect the exterior of the stack and the heater | Yes |
| setting. | |
| Visually check structural members and casing panels | Yes |
| for heat distortion, warping and cracked welds. | |
| Measure exterior temperatures with an infrared | No |
| camera. | |
| Visually inspect bolting at base flange and elevated | Yes |
| sections of the stack for tightness, corrosion and | |
| breakage. | |
| When the heater is not running, test the stack and | Yes |
| casing to check for acidic flue gas corrosion thinning. | |
| When necessary, expand inspection and obtain | No |
| thickness measurements to determine the extent of | |
| damage. | |
| Visually inspect tube penetration seals, manifold | Yes |
| support seals, view port doors, access doors and | |
| explosion doors. Check fit to determine if fit is | |
| satisfactory to prevent air ingress. | |
| Verify that heater panel joints are seal welded or | Yes |
| caulked with high temperature silicone sealant. | |
| Inspect hinges of explosion doors and the door for | Yes |
| warping. Lift doors to check operation. | |

With each best practice being equally weighted, the data in Table 1 is then used to generate a management score for the sub-category of the external inspection of a fired heater as indicated in the method flow chart of FIG. 1. Multiple different ways of calculating the management score are available. In one embodiment, simply the counted number of current practices may be the management score. For example, out of a total of 9 best practices shown in Table 1, 7 are in current practice. Therefore, the management score for the sub-category of the external inspection of a fired heater may be expressed as 7, or 7 out of 9. Alternatively, the management score may be expressed as a percentage, e.g. 78% based on the data in Table 1. Another expression of the management score may be a level or a color. For instance, management scores from 7 to 9 maybe assigned a Level A, management scores from 4 to 6 maybe assigned a Level B, and management scores less than 4 be assigned a Level C. In this type of expression, the management score for the sub-category of the external inspection of a fired heater generated from Table 1 would be a Level A. In another embodiment, color codes may be used instead of letter or number codes. Other mathematical operations or expression may be used as well as other modes of communication.

It is preferred that the individual specific items forming the set of best practices be assigned a weighted value according to the importance of the specific item to the performance of the fired heater. Those specific items having a greater effect on the performance of the fired heater would receive a greater assigned value. A management score based on weighted data may yield a more accurate expression of the effectiveness of the management practices employed regarding the process or equipment. Table 2 shows the sub-category of the external inspection of a fired heater as in Table 1 with the addition of a weight value column with a weight value assigned to each of the listed the best practices. The weight values range from 1 to 5, with 5 being of the greatest importance.

TABLE 2

| | CURRENT | |
|---|---|---|
| BEST PRACTICES | PRACTICE | Weight Value |
| Visually inspect the exterior of the | Yes | 2 |
| stack and the heater setting. | | |
| Visually check structural members and | Yes | 5 |
| casing panels for heat distortion, | | |
| warping and cracked welds. | | |
| Measure exterior temperatures with an | No | 5 |
| infrared camera. | | |
| Visually inspect bolting at base flange | Yes | 3 |
| and elevated sections of the stack for | | |
| tightness, corrosion and breakage. | | |
| When the heater is not running, test | Yes | 2 |
| the stack and casing to check for acidic | | |
| flue gas corrosion thinning. | | |
| When necessary, expand inspection | No | 2 |
| and obtain thickness measurements to | | |
| determine the extent of damage. | | |
| Visually inspect tube penetration seals, | Yes | 3 |
| manifold support seals, view port | | |
| doors, access doors and explosion | | |
| doors. Check fit to determine if fit is | | |
| satisfactory to prevent air ingress. | | |
| Verify that heater panel joints are seal | Yes | 3 |
| welded or caulked with high | | |
| temperature silicone sealant. | | |
| Inspect hinges of explosion doors and | Yes | 1 |
| the door for warping. Lift doors to | | |
| check operation. | | |

With each best practice being assigned a weight value, in one embodiment of the invention the data in Table 2 could be used to generate a weighted management score for the sub-category of the external inspection of a fired heater by simply summing the assigned weight values for the current practices. For the 9 best practices, a total sum of 26 assigned weight values are available. Summing the assigned weight values for the 7 current practices yields 19 weight values. Therefore, the management score may be expressed as 19, or 19 out of 26. Alternatively, the management score may be expressed as a percentage, e.g. 73% based on the data in Table 2. Another expression of the management score may be a level or a color, or other mathematical expression or mode of communication as mentioned above.

Other sub-category, management area, and overall management scores may be calculated in the same fashion as shown above, with management areas and overall management scores likely comprising a much larger data set than shown in Tables 1 and 2. Management scores may be generated for each management area (category) and for each subcategory within the management areas as well. Management scores may be compared to a body of historical management scores in order to evaluate the fired heater against others in the industry, management scores may be compared to one another within a single company to determine where resources or capital should be invested, and management scores could be used to indicate risk and may be used to form correlations with data concerning equipment failures or process upsets.

What is claimed is:

1. A method for determining at least one management score comprising identifying the current practices associated with the management of a process or equipment used in the chemical, petrochemical, or petroleum refining industry and comparing the current practices with a set of best practices associated with the management of the process or equipment to generate a management score.

2. The method of claim 1 wherein the process is selected from the group consisting of alklylation, polymerization, cracking, reforming, isomerization, hydrotreating, sulfur removal processes, aromatics processes, gasification, separations, blending, and combinations thereof.

3. The method of claim 1 wherein the equipment is selected from the group consisting of fired heater, rotating equipment, heat exchangers, boilers, piping, vessels, instrumentation, containment devices, mixing devices, filtering devices, catalyst handling devices, fractionation equipment, and combinations thereof.

4. The method of claim 1 wherein the equipment is selected from the group consisting of pumps, condensers, heat exchangers, fired heaters, boilers, air coolers, water towers, thermocouples, pressure gauges, meters, regulators, valves, on-line analytical instrumentation, laboratory analytical instrumentation, piping, vessels, tanks, static mixers, mix tanks, screens, pads, coalescers, catalyst storage devices, catalyst loading devices, catalyst moving devices, catalyst unloading devices, trays, downcomers, valves, wiers, packing, and spray bars, and combinations thereof.

5. The method of claim 1 wherein the current practices and best practices comprise those selected from the group consisting of inspection practices, maintenance practices, instrumentation practices, training practices, monitoring practices, operating practices, and combinations thereof.

6. The method of claim 1 further comprising determining at least one category management score by grouping the current practices and best practices into categories selected from the group consisting of inspection practices, maintenance practices, instrumentation practices, training practices, monitoring practices, operating practices, and combinations thereof, and comparing the current practices of at least one selected category with the best practices of the corresponding selected category to generate a category management score.

7. The method of claim 1 further comprising repeating the method to generate a second management score.

8. The method of claim 1 further comprising periodically repeating the method to generate a set of management scores that span a period of time.

9. The method of claim 1 wherein the management score is expressed in a form selected from the group consisting of a numerical value, a percentage, chart, graph, level codes, and combinations thereof.

10. The method of claim 1 wherein the management score is compared to a target management score.

11. The method of claim 1 wherein the method is conducted using at least one computer.

12. The method of claim 1 wherein the best practices are weighted according to the effect each practice as on the overall performance of the process or equipment and the management score generated incorporates the weightings.

13. The method of claim 1 further comprising repeating the method on multiples of the selected process or equipment and maintaining a set of the generated management scores.

14. The method of claim 13 further comprising determining statistical information from the set of generated management scores.

15. The method of claim 13 further comprising determining risk information using the set of generated management scores.
